(19) United States
(12) Patent Application Publication
(10) Pub. No.: US 2021/0064818 A1
(43) Pub. Date: Mar. 4, 2021

(54) APPARATUS FOR EXTRACTING SYNTAX AND ELECTRONIC APPARATUS INCLUDING THE SAME

(71) Applicant: LG ELECTRONICS INC., Seoul (KR)

(72) Inventors: Hangyeol SUN, Seoul (KR); Youngwook Kim, Seoul (KR); Hyeyoung Kim, Seoul (KR)

(73) Assignee: LG ELECTRONICS INC., Seoul (KR)

(21) Appl. No.: 17/003,837

(22) Filed: Aug. 26, 2020

(30) Foreign Application Priority Data
Aug. 30, 2019 (KR) 10-2019-0107747

(51) Int. Cl. G06F 40/211; G06F 40/253; G06F 40/289

(52) U.S. Cl. CPC G06F 40/211; G06F 40/289; G06F 40/253

(57) ABSTRACT

Provided are an apparatus for extracting a syntax and an electronic apparatus including the same. The apparatus for extracting a syntax and the electronic apparatus including the same according to embodiments of the present disclosure include a communicator to receive data or transmit data through an external network and a processor to collect text data through the communicator and extract a core syntax based on the collected text data, and the processor collects the text data from a server to provide a social network service through the external network, extracts a sentence from the collected text, and extracts a core syntax based the extracted sentence and a prestored syntax rule. As a result, the text is collected from the server of the social network service to extract effectively extract the core syntax from the collected text.

### CROSS-REFERENCE TO RELATED APPLICATION

Pursuant to 35 U.S.C. § 119(a), this application claims the benefit of earlier filing date and right of priority to Korean Patent Application No. 10-2019-0107747, filed on Aug. 30, 2019, the contents of which are hereby incorporated by reference herein in its entirety.

### BACKGROUND OF THE INVENTION

### 1. Field of the Disclosure

The present disclosure relates to an apparatus for extracting a syntax and an electronic apparatus including the same, and more particularly, to an apparatus for extracting a syntax and an electronic apparatus including the same capable of collecting a text from a server of a social network service and effectively extracting a core syntax from the collected text.

### 2. Related Art

A Social Network Service (hereinafter, referred to as SNS) is an online service that builds a network of people who share a specific interest or activity, and is a generic term of a blog, a mini homepage, a messenger, Twitter, etc., used for people to share their opinions, thoughts, and experiences with each other and in most cases, the people share thoughts with each other through a message composed of short sentences.

SNS data analysis has been actively conducted to look at customer reactions as the number of cases in which consumers directly give feedback to a product or service provider after using a product or service decreases and the consumers frequently leave a review on a personal SNS.

However, due to the nature of SNS next data unlike new data, the SNS text data is mostly constituted by inscriptions, so it is impossible to effectively extract necessary contents using the existing syntax analyzer and systematic research on a method for effectively extracting a meaning has not be conducted.

### SUMMARY OF THE DISCLOSURE

The present disclosure provides an apparatus for extracting a syntax and an electronic apparatus including the same capable of collecting a text from a server of a social network service and effectively extracting a core syntax from the collected text.

In an aspect, provided are an apparatus for extracting a syntax and an electronic apparatus including the same which include: a communicator to receive data or transmit data through an external network and a processor to collect text data through the communicator and extract a core syntax based on the collected text data, and the processor collects the text data from a server to provide a social network service through the external network, extracts a sentence from the collected text, and extracts a core syntax based the extracted sentence and a prestored syntax rule.

Meanwhile, the processor may extract the sentence from the collected text and when a small sentence is included in the extracted sentence, the processor may extract the small sentence and extract the core syntax based on the extracted small sentence.

Meanwhile, in case in which the text is English, the processor may extract an adjective or noun phrase following a verb in the small sentence as the core syntax according to a stored syntax rule.

Meanwhile, in case in which the text is English, the processor may extract the adjective and a prepositional phrase, the adjective and a that clause, or the adjective and a to infinitive in the small sentence as the core syntax based on the stored syntax rule.

Meanwhile, in case in which the text is Korean, the processor may extract the verb or the adjective following a subject in the small sentence as the core syntax based on the stored syntax rule.

Meanwhile, in case in which the processor extracts the sentence from the collected text and the small sentence is not included in the extracted sentence, the processor may immediately extract the core syntax from the extracted sentence.

Meanwhile, the apparatus for extracting a syntax and the electronic apparatus including the same may further include a memory to store the syntax rule.

Meanwhile, the processor may update the syntax rule.

Meanwhile, the processor may extract a dependency relationship in the collected text, extract a comma or period, and extract at least one sentence from the collected text based on the extracted dependency relationship, comma, or period.

Meanwhile, the processor may be configured to output the extracted core syntax to the outside.

Meanwhile, the processor may include a text collector to collect the text data from the server providing the social network service through the external network, a text information extractor to extract the sentence from the collected text, and a core syntax extractor to extract the core syntax based on the extracted sentence and the prestored syntax rule.

Meanwhile, the processor may further include a small sentence extractor to extract the small sentence from the extracted sentence and the core syntax extractor may extract the core syntax based on the extracted small sentence and the syntax rule.

### BRIEF DESCRIPTION OF THE DRAWINGS

The above and other objects, features and advantages of the present disclosure will be more apparent from the following detailed description in conjunction with the accompanying drawings, in which:

FIG. 1 illustrates a syntax extraction system according to an embodiment of the present disclosure;

FIG. 2 is a schematic internal block diagram of an apparatus for extracting a syntax of FIG. 1;

FIG. 3 illustrates an example of the internal block diagram of a processor of FIG. 2;

FIG. 4 is a diagram referred for describing an operation method of an apparatus for extracting a syntax according to an embodiment of the present disclosure; and

FIGS. 5A to 6C are diagrams referred for describing the operation method of FIG. 4.

### DESCRIPTION OF EXEMPLARY EMBODIMENTS

Hereinafter, the present disclosure will be described in more detail with reference to the drawings.

Suffixes “module” and “unit” for components used in the following description are given in consideration of easy preparation of the specification only and do not have their own particularly important meanings or roles. Accordingly, the “module” and “unit” may be used interchangeably.

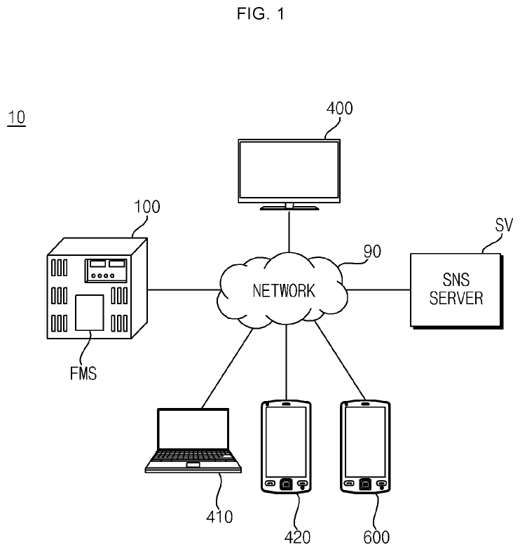

FIG. 1 illustrates a syntax extraction system according to an embodiment of the present disclosure.

Referring to the figure, the syntax extraction system 10 of FIG. 1 may include an image display apparatus 400, a computer 410, a tablet 420, and a mobile terminal 600 connected to a network 90, a server 100 including a syntax extraction apparatus (FMS), and a server SV providing a social network service.

Meanwhile, the syntax extraction apparatus (FMS) according to an embodiment of the present disclosure may be provided in electronic apparatuses including the image display apparatus 400, the computer 410, the tablet 420, the mobile terminal 600, a home appliance, and the like.

Hereinafter, it is mainly described that the syntax extraction apparatus (FMS) is provided in the server 100.

Due to the nature of SNS text data, unlike news data, the SNS text data is mostly constituted by inscriptions, so effective analysis is required.

As a result, the syntax extraction apparatus (FMS) according to an embodiment of the present disclosure collects text data from the server SV providing the social network service through an external network 90, extracts a sentence from the collected text, and extracts a core syntax based on the extracted sentence and a prestored syntax rule. As a result, the text is collected from the server SV of the social network service to extract effectively extract the core syntax from the collected text.

Meanwhile, the syntax extraction apparatus (FMS) extracts the sentence from the collected text and when a small sentence is included in the extracted sentence, the processor may extract the small sentence and extract the core syntax based on the extracted small sentence. As a result, the core syntax can be effectively extracted based on extraction of the small sentence.

Meanwhile, in case in which the text is English, the syntax extraction apparatus (FMS) may extract an adjective or noun phrase following a verb in the small sentence as the core syntax according to a stored syntax rule. As a result, the core syntax can be effectively extracted.

Meanwhile, in case in which the text is English, the syntax extraction apparatus (FMS) may extract the adjective and a prepositional phrase, the adjective and a that clause, or the adjective and a to infinitive in the small sentence as the core syntax based on the stored syntax rule. As a result, the core syntax can be effectively extracted.

Meanwhile, in case in which the text is Korean, the syntax extraction apparatus (FMS) may extract the verb or adjective following a subject in the small sentence as the core syntax based on the stored syntax rule. As a result, the core syntax can be effectively extracted.

Meanwhile, in case in which the syntax extraction apparatus (FMS) extracts the sentence from the collected text and the small sentence is not included in the extracted sentence, the processor may immediately extract the core syntax from the extracted sentence. As a result, the core syntax can be effectively extracted.

Meanwhile, the syntax extraction apparatus (FMS) may update the syntax rule. As a result, the core syntax can be effectively extracted.

Meanwhile, the syntax extraction apparatus (FMS) may extract a dependency relationship in the collected text, extract a comma or period, and extract at least one sentence from the collected text based on the extracted dependency relationship, comma, or period. As a result, at least one sentence can be effectively extracted.

Meanwhile, the syntax extraction apparatus (FMS) may be configured to output the extracted core syntax to the outside. As a result, extracted core syntax information can be provided to the outside.

Meanwhile, the image display apparatus 400 may be a TV, a monitor, a vehicular display apparatus, etc.

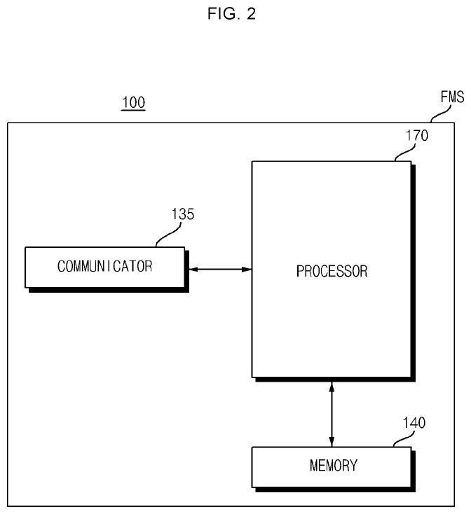

FIG. 2 is a schematic internal block diagram of the server of FIG. 1.

Referring to the figure, syntax extraction apparatus (FMS) in the server 100 may include a communicator 135, a processor 170, and a memory 140.

The communicator 135 may receive data or transmit data from or to the external network 90.

For example, the communicator 135 may receive texts such as news, community posts, and comments from a plurality of external servers.

In particular, the communicator 135 may receive text data from the server SV providing at least one external social network service.

The memory 140 may store data required for the operation of the server 100.

Meanwhile, the memory 140 may store a syntax rule. For example, the memory 140 may store a syntax rule for extracting the sentence, a syntax rule for extracting the small sentence, or a syntax rule for extracting the core syntax.

Meanwhile, the processor 170 may control all operations of the server 100.

Meanwhile, the processor 170 collects text data from the server SV providing the social network service through an external network 90, extracts a sentence from the collected text, and extracts a core syntax based on the extracted sentence and a prestored syntax rule. As a result, the text is collected from the server SV of the social network service to extract effectively extract the core syntax from the collected text.

Meanwhile, the processor 170 extracts the sentence from the collected text and when a small sentence is included in the extracted sentence, the processor may extract the small sentence and extract the core syntax based on the extracted small sentence. As a result, the core syntax can be effectively extracted based on extraction of the small sentence.

Meanwhile, in case in which the text is English, the processor 170 may extract an adjective or noun phrase following a verb in the small sentence as the core syntax according to a stored syntax rule. As a result, the core syntax can be effectively extracted.

Meanwhile, in case in which the text is English, the processor 170 may extract the adjective and a prepositional phrase, the adjective and a that clause, or the adjective and a to infinitive in the small sentence as the core syntax based on the stored syntax rule. As a result, the core syntax can be effectively extracted.

Meanwhile, in case in which the text is Korean, the processor 170 may extract the verb or the adjective following a subject in the small sentence as the core syntax based on the stored syntax rule. As a result, the core syntax can be effectively extracted.

Meanwhile, in case in which the processor 170 extracts the sentence from the collected text and the small sentence is not included in the extracted sentence, the processor may immediately extract the core syntax from the extracted sentence. As a result, the core syntax can be effectively extracted.

Meanwhile, the syntax extraction apparatus (FMS) may further include the memory 140 storing the syntax rule. As a result, the core syntax can be rapidly extracted.

Meanwhile, the processor 170 may update the syntax rule. As a result, the core syntax can be effectively extracted.

Meanwhile, the processor 170 may extract a dependency relationship in the collected text, extract a comma or period, and extract at least one sentence from the collected text based on the extracted dependency relationship, comma, or period. As a result, at least one sentence can be effectively extracted.

Meanwhile, the processor 170 may be configured to output the extracted core syntax to the outside. As a result, extracted core syntax information can be provided to the outside.

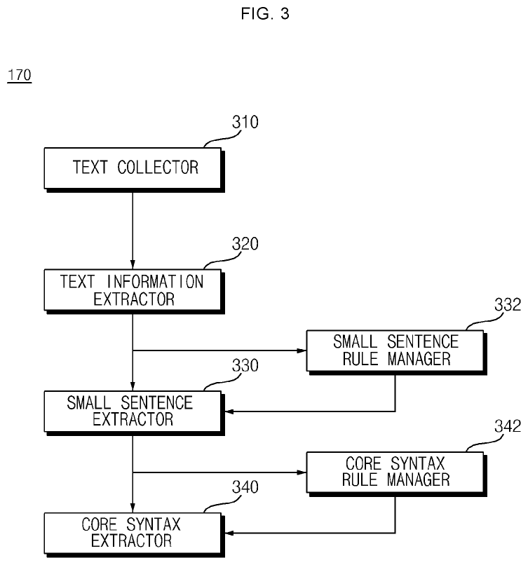

FIG. 3 illustrates an example of the internal block diagram of a processor of FIG. 2.

Referring to the figure, the processor 170 of FIG. 2 may include a text collector 310, a text information extractor 320, a small sentence extractor 330, a core syntax extractor 340, a small sentence rule manager 332, and a core syntax rule manager 342.

The text collector 310 may collect texts from a plurality of servers providing the external social network service. For example, the text collector 310 may collect text data related to posts, comments, etc., from the plurality of servers providing the external social network service.

For example, when text collection is possible, the text collector 310 may directly receive the text data related to the posts, the comments, etc., from the plurality of servers providing the external social network service.

Meanwhile, in case in which the text collection is impossible, the text collector 310 may receive image data related to the posts, the comments, etc., from the plurality of servers providing the external social network service and perform text conversion from the image data. In addition, the text collector 310 may obtain the converted text data.

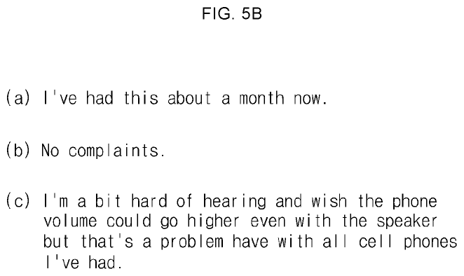

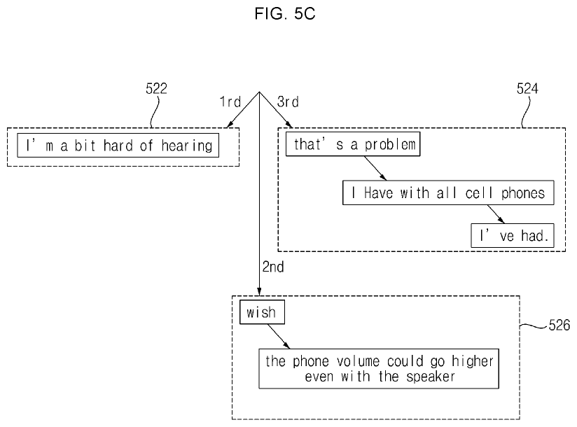

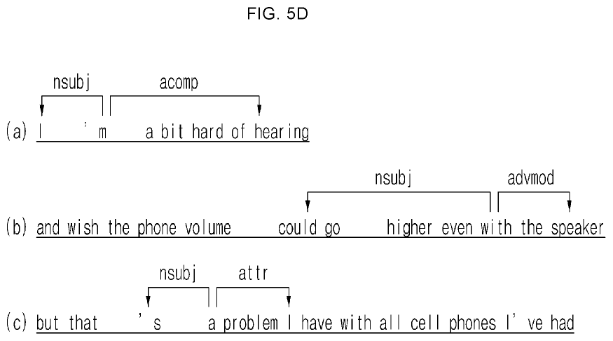

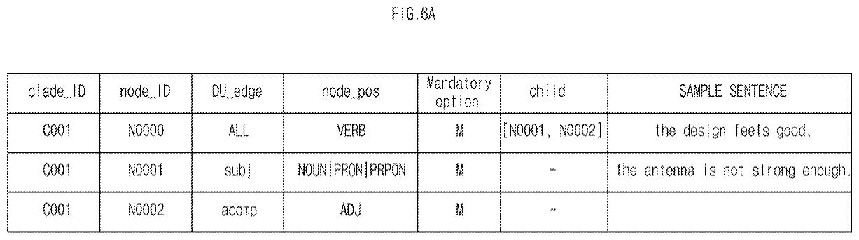

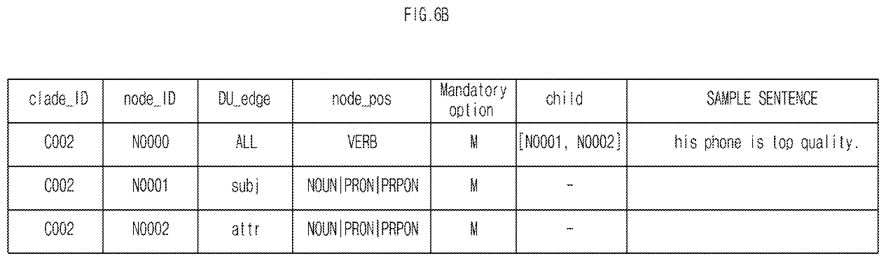

For example, the text collector 310 may collect text data “I've had this about a month now. No complaints. I'm a bit hard of hearing and wish the phone volume could go higher even with the speaker but that's a problem have with all cell phones I've had.” of FIG. 5A.

The text information extractor 320 may extract at least one sentence from the collected text data, in particular, paragraph based text data.

Meanwhile, the text information extractor 320 may extract a dependency relationship in the collected text, extract a comma or period, and extract at least one sentence from the collected text based on the extracted dependency relationship, comma, or period. As a result, at least one sentence can be effectively extracted.

For example, the text information extractor 320 may extract each of “I've had this about a month now.” of FIG. 5B(a), “No complaints.” of FIG. 5B(b), and “I'm a bit hard of hearing and wish the phone volume could go higher even with the speaker but that's a problem have with all cell phones I've had.” of FIG. 5B(c), in the text data of FIG. 5A.

In case in which the small sentence is included in the sentence extracted from the text information extractor 320, the small sentence extractor 330 may extract the small sentence according to a small sentence syntax rule.

Meanwhile, in case in which the small sentence is not included in the sentence extracted from the text information extractor 320, the small sentence extractor 330 may not extract the small sentence.

For example, in case in which the small sentence is not included like “I've had this about a month now.” of FIG. 5B(a) and “No complaints.” of FIG. 5B(b), in the text data of FIG. 5A, the small sentence extractor 330 may not extract the small sentence.

As another example, in case in which the small sentence is included like “I'm a bit hard of hearing and wish the phone volume could go higher even with the speaker but that's a problem have with all cell phones I've had.” of FIG. 5B(c), the small sentence extractor 330 may extract the small sentence according to the small sentence syntax rule.

Meanwhile, when a plurality of small sentences is included, the small sentence extractor 330 may sequentially extract each small sentence.

For example, the small sentence extractor 330 may first extract a first small sentence 522 of “I'm a bit hard of hearing”, extract a second small sentence 526 of “wish/the phone volume could go higher even with the speaker”, and then extract a third small sentence 524 of “that's a problem/I Have with all cell phones/I've had”, as illustrated in FIG. 5C.

Meanwhile, the small sentence extractor 330 may also extract internal small sentences of “that's a problem”, “I Have with all cell phones”, and “I've had” at the time of extracting the third small sentence 524.

Meanwhile, in case in which the small sentence is included in the extracted sentence, the core syntax extractor 340 may extract the small sentence and extract the core syntax based on the extracted small sentence. As a result, the core sentence can be effectively extracted.

Meanwhile, in case in which the small sentence is not included in the extracted sentence, the core syntax extractor 340 may extract the core syntax based on the extracted sentence. As a result, the core syntax can be effectively extracted based on extraction of the small sentence.

Meanwhile, in case in which the text is English, the core syntax extractor 340 may extract an adjective or noun phrase following a verb in the small sentence as the core syntax according to a stored syntax rule. As a result, the core syntax can be effectively extracted.

Meanwhile, in case in which the text is English, the core syntax extractor 340 may extract the adjective and a prepositional phrase, the adjective and a that clause, or the adjective and a to infinitive in the small sentence as the core syntax based on the stored syntax rule. As a result, the core syntax can be effectively extracted.

Meanwhile, in case in which the text is Korean, the core syntax extractor 340 may extract the verb or adjective following a subject in the small sentence as the core syntax based on the stored syntax rule. As a result, the core syntax can be effectively extracted.

For example, the core syntax extractor 340 may extract “hard” which the adjective in the first small sentence of “I'm a bit hard of hearing”, as the core syntax.

As another example, the core syntax extractor 340 may extract “go higher” which is the verb and the adjective in the second small sentence 526 of “wish/the phone volume could go higher even with the speaker”, as the core syntax. In this case, “phone volume” which is the subject may also be together extracted as the core syntax.

As yet another example, the core syntax extractor 340 may extract noun phrase of “problem” in the third small sentence 524 of “that's a problem/I Have with all cell phones/I've had”, as the core syntax.

As a result, the core syntax can be accurately and effectively extracted from the server SV of the social network service.

Meanwhile, the small sentence rule manager 332 may read the small sentence syntax rule stored in the memory 140 and provide the read small sentence syntax rule to the small sentence extractor 330.

Meanwhile, the small sentence rule manager 332 may control the small sentence syntax rule stored in the memory 140 to be updated.

Meanwhile, the core syntax rule manager 342 may read the core syntax rule stored in the memory 140 and provide the read core syntax rule to the core syntax extractor 340.

Meanwhile, the core syntax rule manager 342 may control the small core syntax rule stored in the memory 140 to be updated.

Meanwhile, the processor 170 may be configured to output the extracted core syntax to the outside. For example, the processor 170 may control core syntaxes of “hard”, “go higher”, and “problem” to be output as a sound or image or to be transmitted to external apparatuses.

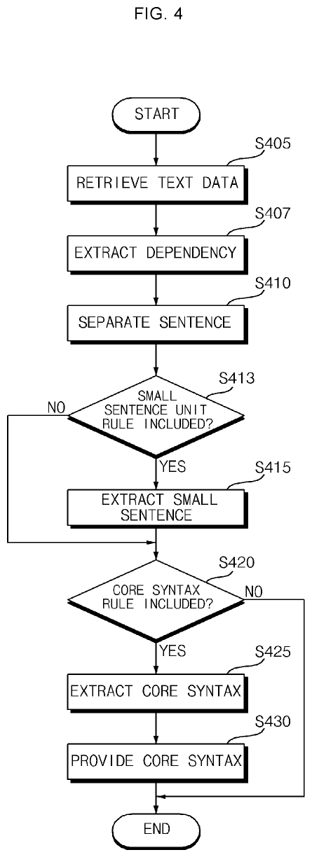

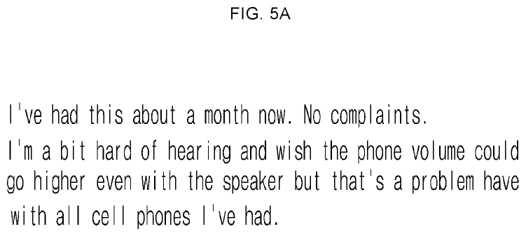

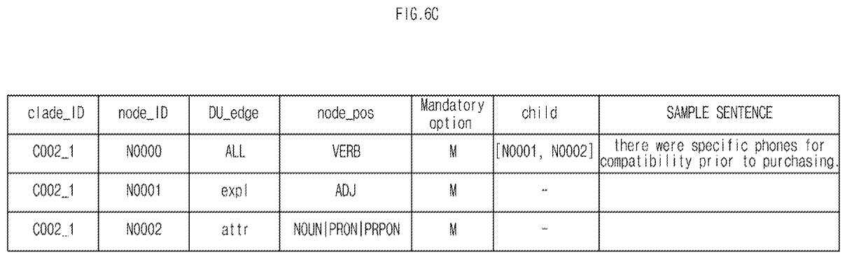

FIG. 4 is a diagram referred for describing an operation method of an apparatus for extracting a syntax according to an embodiment of the present disclosure and FIGS. 5A to 6C are diagrams referred for describing the operation method of FIG. 4.

First, referring to FIG. 4, the text collector 310 in the syntax extraction apparatus (FMS) retrieves and collects text data related to posts, comments, etc., from a plurality of servers providing the external social network service (S405).

For example, the text collector 310 may collect text data “I've had this about a month now. No complaints. I'm a bit hard of hearing and wish the phone volume could go higher even with the speaker but that's a problem have with all cell phones I've had.” of FIG. 5A.

Next, the text information extractor 320 extracts a dependency relationship in the collected text (S407).

Meanwhile, the text information extractor 320 may extract a comma or a period and extract at least one sentence from the collected text based on the dependency relationship, the comma, or the period (S410). As a result, at least one sentence can be effectively extracted.

For example, the text information extractor 320 may extract each of “I've had this about a month now.” of FIG. 5B(a), “No complaints.” of FIG. 5B(b), and “I'm a bit hard of hearing and wish the phone volume could go higher even with the speaker but that's a problem have with all cell phones I've had.” of FIG. 5B(c), in the text data of FIG. 5A.

Next, the small sentence extractor 330 may determine whether a small sentence unit rule is included in the sentence extracted by the text information extractor 320 (S413) and in the corresponding case, the small sentence extractor 330 may determine that the small sentence is included in the extracted sentence and extract the small sentence.

For example, in case in which the small sentence is included like “I'm a bit hard of hearing and wish the phone volume could go higher even with the speaker but that's a problem have with all cell phones I've had.” of FIG. 5B(c), the small sentence extractor 330 may extract the small sentence according to the small sentence syntax rule.

Next, the core syntax extractor 340 may determine whether a core syntax unit rule is included in the extracted small sentence (S420) and in the corresponding case, the core syntax extractor 330 may determine that the core syntax is included in the extracted small sentence and extract the core syntax (S425).

Meanwhile, in case in which the small sentence is not included in the extracted sentence, the core syntax extractor 340 may extract the core syntax based on the extracted sentence.

Meanwhile, in case in which the text is English, the core syntax extractor 340 may extract an adjective or noun phrase following a verb in the small sentence as the core syntax according to a stored syntax rule. As a result, the core syntax can be effectively extracted.

For example, the core syntax extractor 340 may extract “hard” which the adjective in the first small sentence of “I'm a bit hard of hearing”, as the core syntax, as illustrated in FIG. 5D(a).

As another example, the core syntax extractor 340 may extract “go higher” which is the verb and the adjective in the second small sentence 526 of “wish/the phone volume could go higher even with the speaker”, as the core syntax, as illustrated in FIG. 5D(b). In this case, “phone volume” which is the subject may also be together extracted as the core syntax.

As yet another example, the core syntax extractor 340 may extract noun phrase of “problem” in the third small sentence 524 of “that's a problem/I Have with all cell phones/I've had”, as the core syntax, as illustrated in FIG. 5D(c).

As a result, the core syntax can be accurately and effectively extracted from the server SV of the social network service.

Meanwhile, FIG. 6A is a diagram for describing a core syntax rule based on the verb and the adjective.

Referring to the figure, the core syntax extractor 340 may extract the verb and the adjective as the core syntax when the adjective comes after the verb.

The core syntax extractor 340 may extract “feels good” in “the design feels good.” which is the sentence or small sentence illustrated in FIG. 6A as the core syntax.

Meanwhile, the core syntax extractor 340 may extract “not strong enough” in “the antenna is not strong enough.” which is the sentence or small sentence illustrated in FIG. 6A as the core syntax.

Meanwhile, FIG. 6B is a diagram for describing a core syntax rule based on the verb and the noun phrase.

Referring to the figure, the core syntax extractor 340 may extract the verb and the noun phrase as the core syntax when the noun phrase comes after the verb.

The core syntax extractor 340 may extract “is top quality” in “This phone is top quality.” which is the sentence or small sentence illustrated in FIG. 6B as the core syntax.

Meanwhile, FIG. 6C is a diagram for describing another example of the core syntax rule based on the verb and the noun phrase.

Referring to the figure, the core syntax extractor 340 may extract the verb and the noun phrase as the core syntax when the noun phrase comes after the verb.

The core syntax extractor 340 may extract “were specific phones” in “there were specific phones for compatibility prior to purchasing.” which is the sentence or small sentence illustrated in FIG. 6C as the core syntax.

Meanwhile, although not illustrated in the figure, the core syntax extractor 340 may extract the adjective and a prepositional phrase, the adjective and a that clause, or the adjective and a to infinitive in the sentence or small sentence as the core syntax. As a result, the core syntax can be effectively extracted.

For example, the core syntax extractor 340 may extract “disappointed in the quality” which is the adjective and the prepositional phrase in “very disappointed in the quality” which is the sentence or small sentence as the core syntax.

As another example, the core syntax extractor 340 may extract “disappointed that i did not get” which is the adjective and the that clause in “very disappointed that i did not get my free extra battery and charger from bestbuy” which is the sentence or small sentence as the core syntax.

As yet another example, the core syntax extractor 340 may extract “disappointed hard to see” which is the adjective and the to infinitive in “very disappointed hard to see the screen in sun light and ate battery life terrible pictures never would focus right” which is the sentence or small sentence as the core syntax.

As a result, the text is collected from the server of the social network service to extract effectively extract the core syntax from the collected text.

Therefore, it is possible to easily analyze issues that dominate online or the public's thoughts, resulting in more objective analysis results.

In addition, it is possible to easily identify and respond to online issues based on the results, so it is possible to provide an optimal analysis system, and further, various modifications based on big data processing are possible.

As described above, the configurations and the methods of the embodiments described above may not be limitedly applied to the apparatus for extracting a syntax and the electronic apparatus including the same according to the embodiments of the present disclosure, but the embodiments may be configured by selectively combining all or some of the respective embodiments so as to be variously modified.

Further, although the preferred embodiments of the present disclosure have been illustrated and described above, the present disclosure is not limited to the aforementioned specific embodiments, various modifications may be made by those skilled in the art in the technical field to which the present disclosure pertains without departing from the subject matters of the present disclosure that are claimed in the claims, and these modifications should not be appreciated individually from the technical spirit or prospect of the present disclosure.

The apparatus for extracting a syntax and the electronic apparatus including the same according to embodiments of the present disclosure include a communicator to receive data or transmit data through an external network and a processor to collect text data through the communicator and extract a core syntax based on the collected text data, and the processor collects the text data from a server to provide a social network service through the external network, extracts a sentence from the collected text, and extracts a core syntax based the extracted sentence and a prestored syntax rule. As a result, the text is collected from the server of the social network service to extract effectively extract the core syntax from the collected text.

Meanwhile, in case in which the processor extracts the sentence from the collected text and a small sentence is included in the extracted sentence, the processor may extract the small sentence and extract the core syntax based on the extracted small sentence. As a result, the core syntax can be effectively extracted based on the small sentence.

Meanwhile, in case in which the text is English, the processor may extract an adjective or noun phrase following a verb in the small sentence as the core syntax according to a stored syntax rule. As a result, the core syntax can be effectively extracted.

Meanwhile, in case in which the text is English, the processor may extract the adjective and a prepositional phrase, the adjective and a that clause, or the adjective and a to infinitive in the small sentence as the core syntax based on the stored syntax rule. As a result, the core syntax can be effectively extracted.

Meanwhile, in case in which the text is Korean, the processor may extract the verb or the adjective following a subject in the small sentence as the core syntax based on the stored syntax rule. As a result, the core syntax can be effectively extracted.

Meanwhile, in case in which the processor extracts the sentence from the collected text and the small sentence is not included in the extracted sentence, the processor may immediately extract the core syntax from the extracted sentence. As a result, the core syntax can be effectively extracted.

Meanwhile, the apparatus for extracting a syntax and the electronic apparatus including the same may further include a memory to store the syntax rule. As a result, the core syntax can be rapidly extracted.

Meanwhile, the processor may update the syntax rule. As a result, the core syntax can be effectively extracted.

Meanwhile, the processor may extract a dependency relationship in the collected text, extract a comma or period, and extract at least one sentence from the collected text based on the extracted dependency relationship, comma, or period. As a result, at least one sentence can be effectively extracted.

Meanwhile, the processor may be configured to output the extracted core syntax to the outside. As a result, extracted core syntax information can be provided to the outside.

Meanwhile, the processor may include a text collector to collect the text data from the server providing the social network service through the external network, a text information extractor to extract the sentence from the collected text, and a core syntax extractor to extract the core syntax based on the extracted sentence and the prestored syntax rule. As a result, the core syntax can be effectively extracted.

Meanwhile, the processor may further include a small sentence extractor to extract the small sentence from the extracted sentence and the core syntax extractor may extract the core syntax based on the extracted small sentence and the syntax rule. As a result, the core syntax can be effectively extracted.

What is claimed is:

1. An apparatus for extracting a syntax, the apparatus comprising:
a communicator to receive data or transmit data through an external network; and
a processor to collect text data through the communicator and extract a core syntax based on the collected text data,
wherein the processor collects the text data from a server to provide a social network service through the external network, extracts a sentence from the collected text, and extracts the core syntax based on the extracted sentence and a prestored syntax rule.

2. The apparatus for extracting a syntax of claim 1, wherein in case in which the processor extracts the sentence from the collected text and a small sentence is included in the extracted sentence, the processor extracts the small sentence and extracts the core syntax based on the extracted small sentence.

3. The apparatus for extracting a syntax of claim 2, wherein in case in which the text is English, the processor extracts an adjective or noun phrase following a verb in the small sentence as the core syntax based on the stored syntax rule.

4. The apparatus for extracting a syntax of claim 2, wherein in case in which the text is English, the processor extracts the adjective and a prepositional phrase, the adjective and a that clause, or the adjective and a to infinitive as the core syntax based on the stored syntax rule.

5. The apparatus for extracting a syntax of claim 1, wherein in case in which the processor extracts the sentence from the collected text and the small sentence is not included in the extracted sentence, the processor immediately extracts the core syntax from the extracted sentence.

6. The apparatus for extracting a syntax of claim 1, further comprising:
a memory to store the syntax rule,
wherein the processor is configured to update the syntax rule.

7. The apparatus for extracting a syntax of claim 1, wherein the processor extracts a dependency relationship in the collected text, extracts a comma or period, and extracts at least one sentence from the collected text based on the extracted dependency relationship, comma, or period.

8. The apparatus for extracting a syntax of claim 1, wherein the processor is configured to output the extracted core syntax to the outside.

9. The apparatus for extracting a syntax of claim 1, wherein the processor includes a text collector to collect the text data from the server providing the social network service through the external network,
a text information extractor to extract the sentence from the collected text, and
a core syntax extractor to extract the core syntax based on the extracted sentence and the prestored syntax rule.

10. The apparatus for extracting a syntax of claim 9, wherein the processor further includes a small sentence extractor to extract the small sentence from the extracted sentence, and
the core syntax extractor extracts the core syntax based on the extracted small sentence and the syntax rule.

11. An electronic apparatus comprising:
a communicator to receive data or transmit data through an external network; and
a processor to collect text data through the communicator and extract a core syntax based on the collected text data,
wherein the processor collects the text data from a server to provide a social network service through the external network, extracts a sentence from the collected text, and extracts the core syntax based on the extracted sentence and a prestored syntax rule.

12. The electronic apparatus of claim 11, wherein in case in which the processor extracts the sentence from the collected text and a small sentence is included in the extracted sentence, the processor extracts the small sentence and extracts the core syntax based on the extracted small sentence.

13. The electronic apparatus of claim 12, wherein in case in which the text is English, the processor extracts an adjective or noun phrase following a verb in the small sentence as the core syntax based on the stored syntax rule.

14. The electronic apparatus of claim 12, wherein in case in which the text is English, the processor extracts the adjective and a prepositional phrase, the adjective and a that clause, or the adjective and a to infinitive as the core syntax based on the stored syntax rule.

15. The electronic apparatus of claim 11, wherein in case in which the processor extracts the sentence from the collected text and the small sentence is not included in the extracted sentence, the processor immediately extracts the core syntax from the extracted sentence.

16. The electronic apparatus of claim 11, further comprising:
a memory to store the syntax rule,
wherein the processor updates the syntax rule.

17. The electronic apparatus of claim 11, wherein the processor extracts a dependency relationship in the collected text, extracts a comma or period, and extracts at least one sentence from the collected text based on the extracted dependency relationship, comma, or period.

18. The electronic apparatus of claim 11, wherein the processor is configured to output the extracted core syntax to the outside.

19. The electronic apparatus of claim 11, wherein the processor includes a text collector to collect the text data from the server providing the social network service through the external network,
a text information extractor to extract the sentence from the collected text, and
a core syntax extractor to extract the core syntax based on the extracted sentence and the prestored syntax rule.

20. The electronic apparatus of claim 19, wherein the processor further includes a small sentence extractor to extract the small sentence from the extracted sentence, and
the core syntax extractor extracts the core syntax based on the extracted small sentence and the syntax rule.
